(19) United States
(12) Patent Application Publication
(10) Pub. No.: US 2005/0078897 A1
(43) Pub. Date: Apr. 14, 2005

(54) Protection of railway axle and bearing against corrosion

(76) Inventor: Ming Zhang, Montreal (CA)

Correspondence Address: Ming (Jason) Zhang, 5270 Rosedale Avenue, Montreal, QC, H4V 2H6, CA

(21) Appl. No.: 10/766,539

(22) Filed: Jan. 29, 2004

Related U.S. Application Data
(60) Provisional application No. 60/510,042, filed on Oct. 9, 2003.

(51) Int. Cl. F16C 19/50

(52) U.S. Cl. 384/476

(57) ABSTRACT

The present invention provides methods for (1) protecting cathodically critical areas of railway axles against corrosion by depositing selectively sacrificial metal films or mounting sacrificial metal components over those critical contact-free areas such as axle fillet, axle groove, bore surface of bearing backing ring and bore surface of bearing seal wear ring; (2) protecting cathodically internal surfaces of railway bearings against corrosion, by depositing selectively sacrificial metal films or mounting sacrificial metal components over those contact-free internal surfaces within the bearing assembly; (3) protecting critical areas of railway axles against corrosion and impact damages by providing a protective seal made of resilient material to the axle fillet, axle dust guard area, sealing the joint between bearing components and the axle, and adding a resilient protection barrier over those critical areas of the axle.

### 1. CROSS REFERENCE TO RELATED APPLICATIONS

This application claims the benefit of U.S. Provisional Application No. 60/510,042 filed on Oct. 9th, 2003, which is hereby incorporated by reference in its entirety.

### 2. TECHNICAL FIELD

The present invention relates generally to methods and apparatus for protection of machinery components or vehicle components against corrosion under varies conditions. In particular, the present invention relates to cathodic protection and sealing methods against corrosion for critical areas of railway axle such as axle fillet, axle dust guard, as well as critical areas in railway bearing such as backing ring, seal wear ring, cone and bearing cup.

### 3. BACKGROUND OF THE INVENTION

Railway axles presently used are designed to have infinite fatigue life if axle surfaces are kept defect free. However, under constantly increased rail car loading and higher car running speed, and with surface defects caused by corrosion or impacts railway axles have recently experienced high failure rate in terms of axle cracking, leading to high number of catastrophic train derailments, costing the North American railroads millions of dollars.

Almost half of the axle cracking incidents occurs at fillet or groove area where highly concentrated mechanical stresses combines with accelerated localized corrosion. However, for most of axles in service, those critical areas have not been so far fully protected in terms of:
1. Long term corrosion resistance under variable atmospheric conditions;
2. Proper impact resistance against flying hard objects from the road.

The present railway practice requires application of black tare like sealant/rust preventative in axle fillet, axle dust guard and axle groove to protect axle against corrosion pitting. The newly designed fitted bearing backing ring that is fitted onto axle dust guards with a interference does improve the effectiveness of sealing of axle fillet, but still provide no protection on axle dust guards. Furthermore, large population of axles currently in use have smaller diameters in their dust guard areas due to lack of precision during initial machining or due to surface damages during subsequent mounting/dismounting or road services and can not achieve designed interference fit. Those axles can only be used with non-fitted bearing backing ring and can not benefit from the fitted bearing backing ring design.

The investigations/analysis on cracked axles as well as on other secondhand axles back from field services found that axle fillet area or axle groove area are often subject to severe localized corrosion and the sealant/rust preventative presently used cracks and degrades quickly during road service and cease to be effective as physical barrier against water/moisture ingress. The degraded/cracked sealant/rust preventative coatings actually induce severe localized corrosion in the axle fillet or the axle groove that eventually develop into major cracks under car loading.

Actually, many coatings, such as epoxy or polyurethane types, are capable of providing good long-term corrosion protection by developing high bonding strength with substrate and forming firm/tough film on the substrate. Some coatings can even provide certain impact resistance if heavily applied. However, due to following reasons, those coatings are not the most desirable choices:
(1) The insulating nature of those permanent coatings make it difficult to perform conventional non-destructive inspection (NDT) directly over those coatings;
(2) Removal of those permanent coatings from axle as well as from bearing component before NDT is extremely difficult without heavy machining. Furthermore, coating removal by machining can result in reduction of critical axle/bearing dimensions and shorten service lives of axle or bearing components unnecessarily.
(3) More importantly, the use of those thick permanent coatings put axles at extremely high risk in terms of severe localized corrosion once those coatings are accidentally damaged or degraded locally. Actually better the general quality of those coatings, faster the localized corrosion will progress into major cracks once the coating degrade or be damaged, therefore higher risk of axle corrosion cracking in those protected axle fillet or grooved areas.

Regarding to railway roller bearings, certain measures have been taken to protect encased internal moving components against corrosion, such as improved seals, special formulated bearing greases containing corrosion inhibitors. Nevertheless, “water etch”, a kind of corrosion damage due to water ingress, occurs frequently on surfaces of encased internal bearing components, causing sometimes serious bearing failures and catastrophic car accidents.

Accordingly, what are needed in the art are improved methods and apparatus to fully protect railway axles and railway bearings against corrosion during long term field service while keeping the protected area easily inspected and maintained at low cost.

### 4. SUMMARY OF THE INVENTION

One object of the present invention is to provide methods and apparatus that will promote cathodic protection in selected critical areas of railway axle and/or selected critical areas of bearing components, preventing localized corrosion and resulting severe axle corrosion cracking.

Another object of the present invention is to provide methods and apparatus that will protect all critical areas for large population of existing railway axles/axle mounted bearing components from corrosion and impact damages.

Another object of the present invention is to provide those above-mentioned protection methods and apparatus while keeping the protected areas readily accessible for visual or non destructive inspection and allowing conventional bearing mounting/dismounting method be used.

Other objects and advantages of the present invention can become more apparent to those skilled in the art as the nature of the invention is better understood from the accompanying drawings, as well as detailed descriptions.

### 5. BRIEF DESCRIPTION OF THE DRAWINGS

FIG. 1 is a partial cross sectional view of one embodiment of the present invention in which sacrificial metal deposits are selectively applied to critical areas in a railway axle and railway bearing components that are mounted to the axle.

FIG. 1A is an enlarged view of the apparatus depicted in FIG. 1.

FIG. 2 is a cross sectional view of another embodiment of the present invention in which a seal is installed over a railway axle dust guard.

FIG. 3 is a cross sectional view of an alternative to the embodiment shown in FIG. 2.

FIG. 4 is a cross sectional view of another alternative to the embodiment shown in FIG. 2.

### 6. DETAILED DESCRIPTION OF THE DRAWINGS

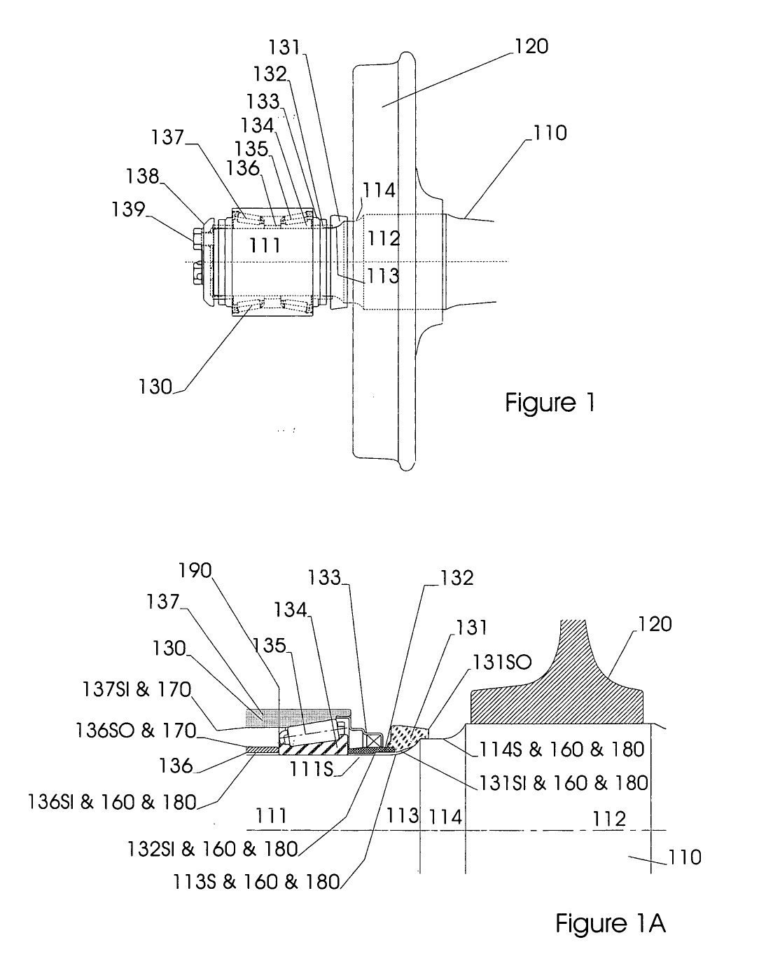

Referring to FIG. 1 and FIG. 1A, half of a railway wheel set is provided including an axle 110, a curved plate wheel 120, a roller bearing assembly 130, an axle sacrificial metal reserve 160, a bearing internal sacrificial metal reserve 170, residual mounting lubricant and sealant 180 and bearing lubrication grease 190.

The wheel 120 is mounted and secured on the axle 110 with interference fit.

The roller bearing assembly 130 includes a fitted backing ring 131, a pair of seal wear rings 132, a pair of bearing seals 133, a pair of bearing cones 134, a plurality of roller 135, a spacer ring 136, a bearing cup 137, an axle end cap 138 and a plurality of cap screws 139.

The straight end section of the axle 110 enveloped by the bearing assembly 130 is referred as axle journal 111. The section of the axle 110 where wheel 120 is mounted is referred as axle wheel seat 112. The relatively smaller diameter curved section of the axle 110 underneath the backing ring 131 is referred as axle fillet 113 and the relatively larger diameter curved section of the axle 110 located between axle fillet 113 and axle wheel seat 112 is referred as axle dust guard 114.

Accordingly, the curved surface area of the axle fillet 113 is referred as axle fillet surface 113S while the curved surface area of the axle dust guard 114 as axle dust guard surface 114S and the straight surface of the axle journal 111 as 111S.

Surfaces of roller bearing components are named in a similar manner except all the bore surfaces being designated with “SI” and the exterior surfaces with “SO”.

The inner bore surfaces in FIG. 1 and FIG. 1A are indicated as following:
131SI for the backing ring 131, 132SI for the seal wear ring 132 and 136SI for the spacer ring 136.

The exterior surfaces in FIG. 1 and FIG. 1A are indicated as following:
131SO for the backing ring 131 and 136SO for the spacer ring 136.

The axle sacrificial metal reserve 160 is a plurality of sacrificial metal films deposited to following areas that remain substantially contact free during and after wheel set assembly:
(A) Portions of inner bore surfaces that remains contact free or be subject to only loose contact, including 131SI of the bearing backing ring 131, 132SI of the seal wear ring 132 and 136SI of the spacer ring 136;
(B) Portions of axle surfaces that remains contact free or be subject to only loose contact including 113S of the axle fillet 113, 114S of the axle dust guard 114 and a portion of 111S of the axle journal 111 underneath the seal wear ring 132.
   The mounting lubricant/sealant 180 is also left on bearing surface and axle surfaces after assembly of the axle 110 and the bearing 130, with relatively large quantity left on above mentioned contact-free portions of bearing surfaces and axle surfaces.

The sacrificial metal films contain, at high percentage, single or multiple metal or alloys that are electrochemically anodic to substrate axle steel or substrate bearing steel. The sacrificial metal films may have a single or multiple layer structure and be applied by single or multiple suitable processes including but not limited to painting, thermal spraying, electroplating, and galvanizing. The preferred deposition processes for the present railway wheel set application are inorganic zinc painting, zinc or Zn—Al thermal spraying, zinc or Zn—Ni brush plating. All those preferred processes are capable of depositing sacrificial metal films locally, selectively and at low temperatures.

Since zinc or zinc alloy film is electrochemically anodic to axle and bearing steel, the zinc or zinc alloy film prevents corrosion of the underlying axle or bearing steel surfaces by providing cathodic sacrifical protection. In addition, the coating forms an impermeable barrier with zinc salts against further water or ion penetration and self heals to resume protection once the painting being damaged accidentally.

The most preferred area for zinc or zinc alloy film deposition are bearing component surfaces such as 131SI, 132SI and 136SI because
A. surface cleaning/film re-deposition can be easily achieved compared with corresponding axle surfaces such as 113S, 114S and 111S.
B. no non-destructive testing is required on those bearing component surfaces.

Under rail car loading, the axle fillet 113 and adjacent areas in the railway axle 110 are subject to locally concentrated mechanical stress due to abrupt diameter changes in the axle fillet 113. To avoid any possible stress concentration, it is a common design practice that mating bearing components, the bearing backing ring 131 and the seal wear ring 132, remain contact free from the axle fillet 113.

Since sacrificial metal films are deposited on those axle fillet surface 113S and on the bore surface 131SI and 132SI of the bearing 130 that remain substantially contact free during and after wheel set assembly, there are no risk of film damages during the bearing mounting process and dismounting process. The sacrificial metal films are also protected by the mounted backing ring 131 during the long-term field services.

During regular inspection or requalification, the previously applied sacrificial metal films can be kept or only partially removed without causing any damages on axle or bearing surfaces and additional films may be further applied afterwards on top of them.

It should be noted that the sacrificial metal films are of any suitable type including but not limited to zinc, zinc alloys, tin, tin alloys, cadmium and aluminum.

It should also be noted that the axle sacrificial metal reserve may be one or a plurality of sacrificial metal strip components mounted to the above-mentioned contact free axle or bearing surfaces. Those mounted metal strips, preferably in zinc or magnesium, act as sacrificial anode, protecting cathodically axle and bearing surfaces in case of water or moisture ingress.

It should also be noted that the sacrificial metal films or sacrificial metal strips may be applied or mounted to above mentioned contact free bearing surfaces only or to above mentioned contact free axle surfaces only. Since bearing 130, axle 110 and residual mounting/sealing compound 180 are all in electrical contact, the sacrificial metal films or mounted sacrificial metal strip components, although only applied or mounted to bearing surfaces or only to axle surfaces, can actually protect both axle and bearing components at the same time. The preferred sacrificial metal film deposition processes in this case are the ones that are capable of depositing dense metal films such as electroplating, brush plating, HVOF thermal spraying, galvanizing.

For example, the zinc electrodeposit or magnesium strip may be applied or mounted only to inner bore surface 131SI of the bearing backing ring 131 and 132SI of the seal wear ring 132. Since
(1) the bearing backing ring 131, the seal wear ring 132 and the axle 110 are electrically connected;
(2) axle surfaces 113S, 111S, bearing surfaces 131SI and 132SI are in contact with residual lubricant/sealant 180 whose conductivity increases in case of water/moisture ingress;
(3) the axle surfaces 113S and 111S are in close proximity to 131SI, 132SI; the zinc electrodeposit or magnesium strip applied to 131SI and 132SI act as sacrificial anode and provide not only cathodic protection to the bearing surfaces 131SI and 132SI, but also to the axle surfaces 113S and 111S.

It should also be noted that the axle sacrificial metal reserve 160 may be one type or a plurality types of sacrificial metal dusts contained, at high percentage, within the bearing mounting lubricant/sealant 180 that is applied on the axle or bearing surfaces before bearing mounting. Upon completion of bearing/axle assembly, the sacrificial metal dusts contained within the residual bearing lubricant/sealant 180 are compacted and deposited to the above-mentioned contact free axle or bearing surfaces. Those metal dusts maintain electrical contact with the axle 110 and the bearing 130, protecting cathodically axle and bearing surfaces in case of water/moisture ingress.

The bearing internal sacrificial metal reserve 170 includes a plurality of sacrificial metal films deposited or a plurality of sacrificial metal strips mounted to the internal bearing areas where no high-pressure contacts will be made among internal bearing components such as the outer bore surface 136SO of the spacer ring 136 and the mid section of the inner bore surface 137SI of the bearing cup 137.

Due to the fact that all internal bearing surfaces are in contact with bearing lubrication grease 190 at the same time, and the electrical conductivity of the grease 190 increases significantly in case of water or moisture ingress, the sacrificial metal films or strips, although applied only to surface 136SO and 137SI, will act as sacrificial anodes and will provide cathodic protection to other internal surfaces of bearing components being in contact with the same bearing lubrication grease 190, for example, the surfaces of the bearing cup 137 and surfaces of the bearing cone 134.

The bearing internal sacrificial metal reserve 170 is made of any suitable metal including but not limited to zinc, zinc alloy, tin, tin alloy, magnesium, cadmium and aluminum.

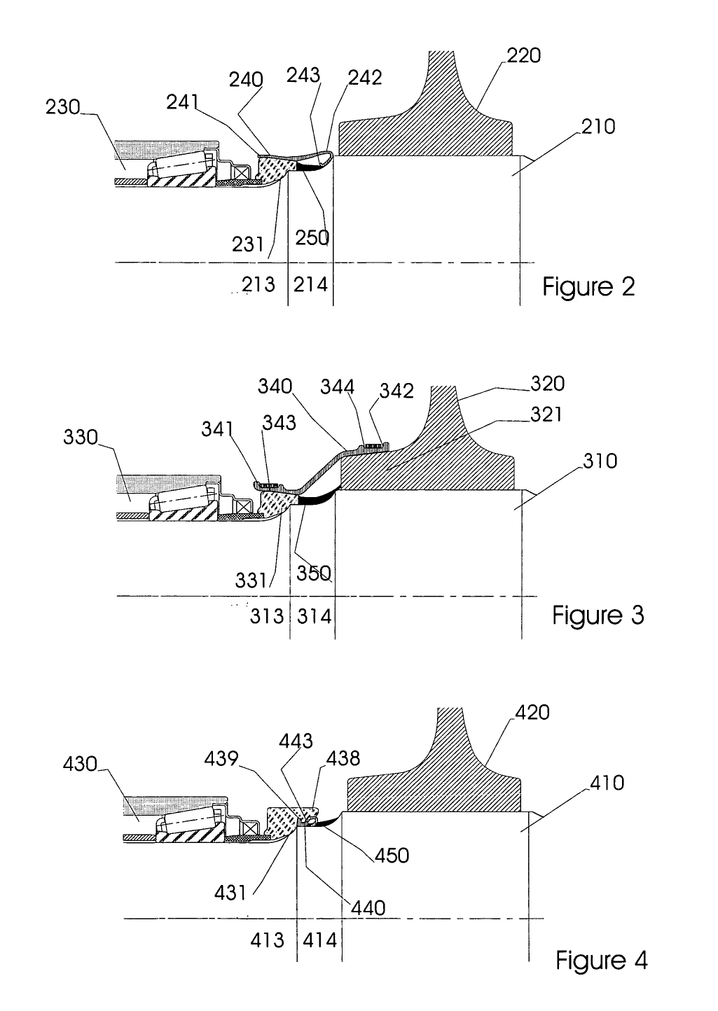

Referring to FIG. 2, a railway wheel set is provided including an axle 210, a curved plate wheel 220, a roller bearing assembly 230, a sealing member in forms of a protective sleeve 240 and a rust preventative/sealant 250.

The structure and assembly of the axle 210, the wheel 220 and the bearing 230 are identical to the axle 110, the wheel 120 and the bearing 130 shown in FIG. 1 and FIG. 1A.

The axle dust guard 214 of the axle 210 has a varying diameter section, thereby defining a minimum diameter at the starting of the axle dust guard 214 and a maximum diameter at the end of the axle dust guard 214.

The protective sleeve 240 has one end 241 pre-mounted and sealed to the external surface of the backing ring 231 of the bearing assembly 230 before bearing mounting. The full sealing is achieved by substantial deformation of initially smaller bore of the pre-mounted end 241 of the protective sleeve 240 than the outside diameter of the backing ring 231. Such sealing may be further enhanced by additional adhesive or tightening device applied to the mounting area. The other end 242 of the sleeve 240 extends out of the backing ring 231 with a length substantially longer than the length of the axle dust guard 214. The end 242 of the sleeve 240 has an inner flange 243 with a diameter larger than minimum diameter of the axle dust guard 214 but substantially smaller than the maximum diameter of the axle dust guard 214.

During final stage of installation of the bearing 230 onto the axle 210, the inner flange 243 of the sleeve 240 starts to engage with the axle dust guard surface 214S and is forced to roll/flip inward before fully resting on the axle dust guard surface 214S. The mid section of the sleeve 240, which is longer than the axle dust guard 214, is forced to climb and roll onto the axle dust guard surface 214S, creating a bulged double seal in the varying diameter section of the axle dust guard surface 214S.

Under rail car loading, the axle fillet 213 and adjacent axle dust guard 214 in the railway axle 210 are subject to locally concentrated mechanical stress due to abrupt diameter changes in the axle fillet 213 and the axle dust guard 214. Upon presence of corrosive ingredients, an accelerated corrosion stress cracking can quickly develop and lead to catastrophic axle failure. The installed sleeve 240 prevents occurrence of corrosion stress cracking by effectively stopping the ingress of any corrosive ingredients. The sleeve 240 not only provides effective seal for the axle dust guard area but also forms an additional sealing for the axle fillet 213 that is primarily protected by bearing backing ring fitted type or non fitted type. The protruded bulgy section of the sleeve 240 also protects the axle dust guard 214 against impact and protects rust preventative/sealing compound 250 that is applied on the axle dust guard surface 214S and now rests underneath the sleeve 240, against impact and UV aging.

The protective sleeve 240 is made of any suitable material including but not limited to polyurethane, neoprene, nitrile or fluoroelastomer, other rubber, other elastomeric or plastic material.

Upon disassembly of the roller bearing 230 from the axle 210, the protective sleeve 240 can be easily removed from the axle 210 together with the bearing backing ring 231. The flexible and thin walled sleeve 240 can be deformed during the bearing dismounting process, allowing direct usage of regular tool for bearing removal.

Referring to FIG. 3, an alternative embodiment of sealing member is provided in an identical railway wheel set arrangement as presented in FIG. 2. The alternative embodiment includes an axle 310, a wheel 320, a roller bearing assembly 330, rust preventative/sealant 350 and a sealing member in form of protective sleeve 340.

Upon completion of the wheel set assembly, the protective sleeve 340 has one end 341 mounted to the backing ring 331 and the other end 342 mounted to the adjacent hub section 321 of the wheel 320.

The sleeve 340 is either pre-mounted to the backing ring 331 or pre-mounted to the wheel hub 321. The other end of the sleeve will be self-mounted upon installation of the roller bearing 330 to the axle 310. The mounted sleeve 340 may be further secured on the backing ring 331 or on the wheel hub 321, either by a pair of clamp means 343 and 344 as shown in FIG. 3 or by a suitable adhesive/sealant.

The mid section of the sleeve 340 is substantially longer than the length of the axle dust guard 314 thereby once bearing 330 is fully installed on axle 310, the sleeve 340 becomes bulgy, being forced into close contact with both backing ring and wheel hub, and remaining tightly sealed during long term field service. The installed sleeve 340 seals not only the axle dust guard area but also forms an additional sealing for the axle fillet 313 that is primarily protected by bearing backing ring, fitted type or non fitted type. The bulged section of the sleeve 340 also protects the axle dust guard 314 against impact, and protects rust preventative/sealant 350 that is applied on the axle dust guard surface 314S and now underneath the sleeve 340, against impact and UV aging.

The protective sleeve 340 is made of any suitable material including but not limited to polyurethane, neoprene, nitrile or fluoroelastomer, other rubber, other elastomeric or plastic material.

Upon disassembly of the wheel set, the flexible and thin walled sleeve 340 can be deformed during the bearing dismounting process, allowing direct usage of regular tool for easy bearing removal. The sleeve 340 can also be safely removed for reuse by flipping/rolling over to the backing ring 331 and dismounted from the axle 310 together with bearing assembly 310.

Thanks to substantially large elastic deformation range of the elastomeric sealing material, the protective sleeve 240 and 340 are able to provide effective sealing in large axle diameter range and in large bearing backing diameter range, allowing direct applications of the arrangements presented in FIG. 2 and FIG. 3 on large population of existing railway axles and railway bearings with dimensions being significantly out of original manufacture tolerances.

Referring to FIG. 4, another alternative embodiment of sealing member is provided to an identical railway wheel set arrangement as presented in FIG. 2, except the bearing backing ring 431 is a non fitted type of backing ring.

Instead of pre-mounting to the external surface of the bearing backing ring as shown in FIG. 2, the sealing member 440 in FIG. 4 is pre-mounted to the inner surface of the bearing backing ring 431, with the help of groove 439 created at the end 438 of the backing ring 431.

The sealing member 440 is pre-mounted into the groove 439. The pre-mounted end of the sealing member 440 has inner diameter substantially smaller and outer diameter substantially larger than the axle dust guard 414. Upon installation of the bearing 430 onto the axle 410, the sealing member 440 is substantially deformed, filling the gaps between the axle dust guard and the end of the bearing backing ring and forming additional sealing for the axle fillet 413. The sealing member 440 made of an elastomer provides protection against impact damages for a portion of the axle dust guard 414.

Thanks to substantially large elastic deformation range of the elastomeric sealing material, the sealing member 440 is able to provide effective sealing in much larger axle diameter ranges than the existing fitted type backing ring made in steel, allowing direct applications of the arrangement presented in FIG. 4 on large population of existing railway axles and railway bearings with dimensions being significantly out of original manufacture tolerances.

1. An apparatus for protection of an assembly of shaft/shaft mounted components against corrosion in a machinery or a vehicle, the apparatus comprising at least:
(a) A shaft and shaft mounted components with bores fitted to said shaft;
(b) Shaft mounting surfaces that are portions of the shaft surfaces underneath or in close proximity to shaft mounted components;
(c) Mounting bore surfaces that are bore surfaces of the shaft mounted components fitted to the shaft;
(d) Stress concentrated areas that are portions of the shaft mounting surfaces or portions of the mounting bore surfaces being subject to local high mechanical stresses;
(e) Reserves of sacrificial metal being either mounted or deposited, at least partially, to said shaft mounting surfaces and/or to said mounting bore surfaces, said reserves of sacrificial metal being connected electrically to the shaft and to the shaft mounted components, said reserves of sacrificial metal being anodic to the shaft and to the shaft mounted components therefore providing cathodic protection to both the shaft and the shaft mounted components against corrosion and preventing corrosion related failures in stress concentrated areas.

2. he apparatus for protection of the assembly of shaft/shaft mounted components against corrosion in a machinery or a vehicle, as recited in claim 1, wherein
(a) the shaft mounting surfaces have at least a contact free shaft mounting area that is substantially free from contact with the shaft mounted components after completion of the assembly of shaft/shaft mounted components;
(b) the mounting bore surfaces have at least a contact free mounting bore area that is substantially free from contact with the shaft after completion of the assembly of shaft/shaft mounted components;
(c) the stress concentrated areas is substantially included in the contact free shaft mounting area or in the contact free mounting bore surfaces.
(d) the reserves of sacrificial metal are either mounted or deposited to said contact free shaft mounting areas and/or to said contact free mounting bore areas, said reserves of sacrificial metal being connected electrically to the shaft and to the shaft mounted components, said reserves of sacrificial metal being anodic to the shaft and to the shaft mounted components therefore providing cathodic protection to both the shaft and the shaft mounted components against corrosion and preventing corrosion related failures in the stress concentrated areas.

3. The apparatus for protection of the assembly of shaft/shaft mounted components against corrosion in a machinery or a vehicle, as recited in claim 1, wherein the reserves of sacrificial metal are zinc or zinc alloy deposited to the shaft mounting surfaces or to the mounting bore surfaces.

4. The apparatus for protection of the assembly of shaft/shaft mounted components against corrosion in a machinery or a vehicle, as recited in claim 1, wherein the reserves of sacrificial metal are zinc or zinc alloy deposited to the shaft mounting surfaces or to the mounting bore surfaces by inorganic zinc silicate coating, electroplating, thermal spraying or galvanizing.

5. The apparatus for protection of the assembly of shaft/shaft mounted components against corrosion in a machinery or a vehicle, as recited in claim 1, wherein
(a) the shaft mounting surfaces and the mounting bore surfaces are covered by residual mounting lubricant/sealant;
(b) the reserves of sacrificial metal are sacrificial metals contained within the residual mounting lubricant/sealant that are deposited to the shaft mounting surfaces and to the mounting bore surfaces.

6. The apparatus for protection of the assembly of shaft/shaft mounted components against corrosion in a machinery or a vehicle, as recited in claim 1, wherein the reserves of sacrificial metal being either mounted or deposited, at least partially, to said shaft mounting surfaces only or to said mounting bore surfaces only, said reserves of sacrificial metal being connected electrically to the shaft and to the shaft mounted components, said reserves of sacrificial metal being anodic to the shaft and to the shaft mounted components: therefore providing cathodic protection to both the shaft mounting surfaces and to the mounting bore surfaces against corrosion and preventing corrosion related failures in stress concentrated areas.

7. The apparatus for protection of the assembly of shaft/shaft mounted components against corrosion in a machinery or a vehicle, as recited in claim 2, wherein
(a) the contact-free shaft mounting areas are portions of shaft fillet and its immediate peripheries or portions of shaft groove and its immediate peripheries that are substantially free from contact with the shaft mounted components after completion of assembly of shaft/shaft mounted components;
(b) the contact-free mounting bore areas are portions of the bore surfaces of the shaft mounted components being fitted over or in close proximity to the shaft fillet or the shaft groove.

8. The apparatus for protection of the assembly of shaft/shaft mounted components against corrosion in a machinery or a vehicle, as recited in claim 2, wherein
(a) the assembly of shaft/shaft mounted component is an assembly of axle/axle mounted bearing of a railway vehicle;
(b) the contact-free shaft mounting areas are portions of axle fillet surfaces, axle groove surfaces, axle journal surfaces or axle dust guard surfaces being substantially free from contact with the axle mounted bearing;
(c) the contact-free mounting bore areas are portions of bore surfaces of the axle mounted bearing components including backing rings, seal wear rings and spacer rings.

9. An apparatus for protection of internal surfaces of shaft mounted components against corrosion in a machinery or a vehicle, the apparatus comprising at least:
(a) A shaft and shaft mounted components;
(b) Internal lubricant encased within the shaft mounted components;
(c) Contact-free internal areas that are portions of internal surfaces of the shaft mounted components being in contact with the internal lubricant and being substantially free from contact with other shaft mounted components;
(d) Internal reserves of sacrificial metal being either mounted or deposited, at least partially, to said contact-free internal areas, said internal reserves of sacrificial metal being connected electrically to the shaft mounted components, said internal reserves of sacrificial metal being anodic to the shaft mounted components therefore providing cathodic protection to the shaft mounted components against corrosion.

10. The apparatus for protection of internal surfaces of shaft mounted components against corrosion in a machinery or a vehicle, as recited in claim 9, wherein the internal reserves of sacrificial metal are zinc or zinc alloy deposited to the contact-free internal areas.

11. The apparatus for protection of internal surfaces of shaft mounted components against corrosion in a machinery or a vehicle, as recited in claim 9, wherein the internal reserves of sacrificial metal are magnesium or magnesium alloys and are mounted to the contact-free internal areas.

12. The apparatus for protection of internal surfaces of shaft mounted components against corrosion in a machinery or a vehicle, as recited in claim 9, wherein
(a) the assembly of shaft/shaft mounted component is an assembly of axle/axle mounted bearing of a railway vehicle;
(b) the contact-free internal areas are portions of bearing cup surface, bearing spacer ring surface being in contact with internal lubricant and being substantially free from contact with other bearing components.

13. An apparatus for protection of an assembly of shaft/shaft mounted components against corrosion and/or impact damages in a machinery or a vehicle, the apparatus comprising at least:
(a) A shaft with one or a plurality of adjacent varying diameter sections thereby defining, in each section, a maximum sectional diameter and a minimum sectional diameter;
(b) Shaft mounted components, mounted to said shaft with at least one gap between the shaft mounted components, said gap making one of the varying diameter sections of said shaft exposed to corrosion or impact damages and defining an exposed varying diameter section of said shaft;
(c) Stress concentrated areas that are portions of the adjacent varying diameter sections of said shaft or portions of the shaft mounted components, said stress concentrated areas being subject to local high mechanical stresses;
(d) A sealing member in resilient material, being mounted to the exposed varying diameter section of said shaft together with one of the shaft mounted components, covering at least partially said exposed varying diameter section of said shaft against possible impact damages, sealing at least one of the joints between the exposed varying diameter section of said shaft and the shaft mounted components, protecting the stress concentrated area within or adjacent to the exposed varying diameter section against possible corrosion damages.

14. The apparatus for protection of the assembly of shaft/shaft mounted components against corrosion and/or impact damages in a machinery or a vehicle, as recited in claim 13, wherein the sealing member is at one end mounted/sealed on one of the shaft mounted components and at the other end mounted/sealed to the exposed varying diameter section of the shaft, said the other end of the sealing member having a bore diameter substantially smaller than the maximum sectional diameter of the exposed varying diameter section but larger than the minimum sectional diameter of the exposed varying diameter section and having a body length substantially longer than the exposed varying diameter section of the shaft.

15. The apparatus for protection of the assembly of shaft/shaft mounted components against corrosion and/or impact damages in a machinery or a vehicle, as recited in claim 13, wherein the sealing member is at one end mounted/sealed on one of the shaft mounted components and at the other end mounted/sealed on the other shaft mounted component, said sealing member having a body length substantially longer than the exposed varying diameter section of the shaft.

16. The apparatus for protection of the assembly of shaft/shaft mounted components against corrosion and/or impact damages in a machinery or a vehicle, as recited in claim 13, wherein
(a) the assembly of shaft/shaft mounted components is an assembly of axle/axle mounted bearing/axle mounted wheel of a railway vehicle;
(b) the shaft varying diameter sections are axle dust guard section, axle fillet section or axle groove section adjacent to the axle mounted wheel and/or the axle mounted bearing;
(c) the sealing member is made of elastomer and is mounted to outer or inner periphery of a ring component of the axle mounted bearing.

17. A method for protection of an assembly of shaft/shaft mounted components against corrosion in a machinery or a vehicle, the method comprising at least:
(a) Determining stress concentrated areas on the shaft surfaces and/or on the bore surfaces of the shaft mounted components that are subject to local high mechanical stresses;
(b) Selecting a contact-free shaft mounting area and/or a contact-free mounting bore area, said contact-free shaft mounting areas being a portion of the shaft surface substantially free from contact with the shaft mounted component and in close proximity to said stress concentrated areas, said contact-free mounting bore areas being a portion of the bore surface of the shaft mounted components substantially free from contact with the shaft and in close proximity to said stress concentrated areas;
(c) Mounting or depositing, at least partially, reserves of sacrificial metal to said selected contact-free shaft mounting areas and/or to said selected contact-free mounting bore areas, said reserves of sacrificial metal being connected electrically to the shaft and the shaft mounted components, said reserves of sacrificial metal being anodic to the shaft and to the shaft mounted components therefore providing cathodic protection to both the shaft and the shaft mounted components against corrosion and preventing corrosion related failures in stress concentrated areas;
(d) Installing the shaft mounted components by the bores to the shaft.

18. The method for protection of the assembly of shaft/shaft mounted components against corrosion in a machinery or a vehicle, as recited in claim 17, wherein the reserves of sacrificial metal are zinc or zinc alloy deposited to the contact-free shaft mounting areas or to the contact-free mounting bore areas.

19. The method for protection of the assembly of shaft/shaft mounted components against corrosion in a machinery or a vehicle, as recited in claim 17, wherein the reserves of sacrificial metal are zinc or zinc deposited to the contact-free shaft mounting areas or to the contact-free mounting bore areas by inorganic zinc silicate coating, electroplating, thermal spraying or galvanizing.

20. The method for protection of the assembly of shaft/shaft mounted components against corrosion in a machinery or a vehicle, as recited in claim 17, wherein the reserves of sacrificial metal are deposited to the contact-free shaft mounting areas and to the contact-free mounting bore areas together with mounting lubricant/sealant prior to the assembly of shaft/shaft mounted component.

21. The method for protection of the assembly of shaft/shaft mounted components against corrosion in a machinery or a vehicle, as recited in claim 17, wherein the reserves of sacrificial metal being either mounted or deposited, at least partially, to said contact free shaft mounting areas only or to said contact free mounting bore areas only, said reserves of sacrificial metal being connected electrically to the shaft and to the shaft mounted components, said reserves of sacrificial metal being anodic to the shaft and to the shaft mounted components therefore providing cathodic protection to both the shaft surfaces and to the bore surfaces against corrosion and preventing corrosion related failures in stress concentrated areas.

22. The method for protection of the assembly of shaft/shaft mounted components against corrosion in a machinery or a vehicle, as recited in claim 17, wherein
(a) the contact-free shaft mounting areas are portions of shaft fillet and its immediate peripheries or portions of shaft groove and its immediate peripheries that are substantially free from contact with the shaft mounted components after completion of assembly of shaft/shaft mounted components;
(b) the contact-free mounting bore areas are portions of the bore surfaces of the shaft mounted components being fitted over or in close proximity to the shaft fillet or the shaft groove.

23. The method for protection of the assembly of shaft/shaft mounted components against corrosion in a machinery or a vehicle, as recited in claim 17, wherein
(a) the assembly of shaft/shaft mounted component is an assembly of axle/axle mounted bearing/axle mounted wheel of a railway vehicle;
(b) the contact-free shaft mounting areas are portions of axle fillet surfaces, axle groove surfaces, axle journal surfaces and axle dust guard surfaces being substantially free from contact with the axle mounted components;
(c) the contact-free mounting bore areas are portions of bore surfaces of axle mounted bearing components including backing rings, seal wear rings and spacer rings.

24. A method for protection of internal surfaces of shaft mounted components against corrosion in a machinery or a vehicle, the apparatus comprising at least:
(a) Selecting contact-free internal areas that are portions of internal surfaces of the shaft mounted components being in contact with internal lubricant and being substantially free from contact with other shaft mounted components once the shaft mounted components are assembled to the shaft;
(b) Mounting or depositing internal reserves of sacrificial metal, at least partially, to said contact-free internal areas, said internal reserves of sacrificial metal being connected electrically to the shaft mounted components, said internal reserves of sacrificial metal being anodic to the shaft mounted components therefore providing cathodic protection to the shaft mounted components against corrosion;
(c) Adding internal lubricant to the internal surface of shaft mounted components;
(d) Installing the shaft mounted components to the shaft.

25. The method for protection of internal surfaces of shaft mounted components against corrosion in a machinery or a vehicle, as recited in claim 24, wherein the internal reserves of sacrificial metal are zinc or zinc alloy deposited to the contact-free internal areas.

26. The method for protection of internal surfaces of shaft mounted components against corrosion in a machinery or a vehicle, as recited in claim 24, wherein the internal reserves of sacrificial metal are magnesium or magnesium alloys and are mounted to the contact-free internal areas.

27. The method for protection of internal surfaces of shaft mounted components against corrosion in a machinery or a vehicle, as recited in claim 24, wherein
(a) the assembly of shaft/shaft mounted component is an assembly of axle/axle mounted bearing of a railway vehicle;
(b) Contact-free internal areas are portions of bearing cup surface, bearing spacer ring surface being in contact with internal lubricant and being substantially free from contact with other bearing components.

28. A method for protection of an assembly of shaft/shaft mounted components against corrosion and/or impact damages in a machinery or a vehicle, the method comprising at least:
(a) Determining maximum sectional diameters and minimum sectional diameters in one or a plurality of adjacent varying diameter sections of said shaft;
(b) Mounting shaft mounted components, to said shaft with at least a gap between the shaft mounted components, said gap making one of the varying diameter sections of said shaft exposed to corrosion or impact damages and defining an exposed varying diameter section of said shaft;
(c) Mounting a sealing member in resilient material to the exposed varying diameter section of said shaft, said sealing member protecting at least partially the exposed varying section of said shaft against possible impact damages, sealing at least one of the joints between the exposed varying diameter section of said shaft and the shaft mounted components, protecting stress concentrated areas on the surface of said shaft within or adjacent to the exposed varying diameter section against possible corrosion damages, said stress concentrated areas being subject to local high mechanical stresses.

29. The method for protection of the assembly of shaft/shaft mounted components against corrosion and/or impact damages in a machinery or a vehicle, as recited in claim 28, wherein the sealing member is at one end mounted/sealed on one of the shaft mounted components and at the other end mounted to the exposed varying diameter section of the shaft, said the other end of the sealing member having a bore diameter substantially smaller than the maximum sectional diameter of the exposed varying diameter section but larger than the minimum sectional diameter of the exposed varying diameter section and having a body length substantially longer than the exposed varying diameter section of the shaft.

30. The method for protection of the assembly of shaft/shaft mounted components against corrosion and/or impact damages in a machinery or a vehicle, as recited in claim 28, wherein the sealing member is at one end mounted/sealed on one of the shaft mounted components and at the other end mounted/sealed on the other shaft mounted component, said sealing member having a body length substantially longer than the exposed varying diameter section of the shaft.

31. The method for protection of the assembly of shaft/shaft mounted components against corrosion and/or impact damages in a machinery or a vehicle, as recited in claim 28, wherein
(a) the assembly of shaft/shaft mounted components is an assembly of axle/axle mounted bearing/axle mounted wheel of a railway vehicle;
(b) the varying diameter sections of said shaft are the axle dust guard section, axle fillet section or axle groove section adjacent to the axle mounted wheel and to the axle mounted bearing.
(c) the sealing member is made of elastomer and is mounted to outer or inner periphery of a ring component of the axle mounted bearing.
